(19) United States
(12) Patent Application Publication
(10) Pub. No.: US 2020/0328053 A1
(43) Pub. Date: Oct. 15, 2020

(54) TEMPERATURE CONTROLLER WITH THERMAL PROTECTION

(71) Applicant: XIAMEN SET ELECTRONICS CO., LTD, Xiamen (CN)

(72) Inventor: Yaoxiang HONG, Xiamen (CN)

(73) Assignee: XIAMEN SET ELECTRONICS CO., LTD, Xiamen (CN)

(21) Appl. No.: 16/958,801

(22) PCT Filed: Mar. 26, 2019
(86) PCT No.: PCT/CN2019/079721

§ 371 Date: Jun. 29, 2020

(30) Foreign Application Priority Data
Apr. 8, 2018 (CN) 201820485602.4

(51) Int. Cl. H01H 37/52; H05B 1/02

(52) U.S. Cl. CPC H01H 37/52; H05B 1/0213; H05B 1/0205

(57) ABSTRACT

A temperature controller with thermal protection includes an action unit and a thermal fuse device that are tightly adjacent and connected in series, wherein the action unit includes a movable contact device and a fixed contact device; the movable contact device includes a bimetallic strip and a movable contact; the fixed contact device includes a fixed contact configured to be correspondingly in contact with the movable contact; the movable contact and the fixed contact are disconnected or connected under an action of the bimetallic strip; and an action temperature of the thermal fuse device is higher than an action temperature of the bimetallic strip.

### CROSS REFERENCE TO THE RELATED APPLICATIONS

This application is the national phase entry of International Application No. PCT/CN2019/079721, filed on Mar. 26, 2019, which is based upon and claims priority to Chinese Patent Application No. 201820485602.4, filed on Apr. 8, 2018, the entire contents of which are incorporated herein by reference.

### TECHNICAL FIELD

The present invention relates to a temperature controller, and in particular to a temperature controller with thermal protection.

### BACKGROUND

A temperature controller is a series of automatic control elements that generate physical deformation in a switch according to the temperature change of the operating environment, thereby generating some special effects and generating on or off actions. The demand for temperature controllers increases as the demand for home appliances increases. At present, there are the following four commonly used temperature controllers: a steam pressure temperature controller, a snap-action temperature controller, a capillary temperature controller and an electronically controlled temperature controller. Compared with other temperature controllers, the snap-action temperature controller has the advantages of reasonable price, convenient installation and maintenance, high temperature control accuracy, low interference to radio and audio-visual appliances, and so on, which is widely used in industrial circuits, motors, home appliances, automobiles and other fields.

The snap-action temperature controller is a temperature controller that uses a bimetallic strip as a temperature sensing component. The bimetallic strip is a composite material composed of two or more metals or other materials with suitable properties. Since the thermal expansion coefficients of the layers are different, when the temperature changes, the deformation of the active layer is greater than the deformation of the passive layer, so that the entire bimetallic strip will be bent toward the side of the passive layer, and the curvature of this composite material changes to produce deformation.

When electrical equipment is operating normally, the bimetallic strip is in a free state, and contacts are connected/disconnected. When the temperature reaches an action temperature, the bimetallic strip is heated to generate internal stress and act quickly to disconnect/connect the contacts and turn off/on the circuit, thereby playing a function of temperature control. When the electrical equipment is cooled to a reset temperature, the contacts are automatically connected/disconnected to restore a normal operating state.

The snap-action temperature controllers are divided into a slow-motion type, a flashing type and a snap-action type according to the action mode of contact clutch. Their principles are all that when an overcurrent or short circuit occurs in a circuit, a large amount of heat is generated in the circuit, thereby generating deformation to cut off the circuit. No matter what kind of temperature controller, there are many internal and external factors that affect the connection/disconnection of the contacts, and the process of studying the connection/disconnection of the contacts is also extremely complicated. Contact arc, contact material, contact plating, contact gap, contact form of contact, overtravel, internal excess, contact bounce, contact load characteristics, etc., and even the interference of circuitry electromagnetic field, temperature and humidity, and various manufacturing errors will all directly or indirectly affect the failure of the contacts of the temperature controller. In the process of use, there may be faults such as contact adhesion, excessive contact resistance, arc drawing, etc., so that the bimetallic strip cannot operate normally, and the circuit cannot be turned on/off in time, resulting in the occurrence of secondary disasters.

When the snap-action temperature controller is used in a circuit, it is usually used in combination with a thermal fuse. When the temperature rises abnormally in the circuit, a normally closed temperature controller acts as a control unit to turn off the circuit in time. When the control unit fails and the contacts are adhered, the thermal fuse of the circuit connected in series acts as a protection unit, which can sense an abnormal temperature rise and cut off the circuit, eliminating potential risks.

However, the snap-action temperature controller and the thermal fuse are usually not adjacent on the circuit, and they are two independent components which are separated by other components. When an overcurrent or short circuit occurs in a circuit, the contacts are adhered and a local temperature rises, and the remote thermal fuse cannot absorb heat in time. When the local temperature rises too high, it may cause further failure. Moreover, the snap-action temperature controller and the thermal fuse are two components, and in the installation process, multiple processes need to be added, which affects the manufacturing cost.

### SUMMARY

In order to solve the above existing problems, an objective of the present invention is to provide a temperature controller with thermal protection, which provides an effective thermal protection execution cut-off mode for a circuit required to be protected.

The objective of the present invention is achieved by the following technical solutions.

A temperature controller with thermal protection, including an action unit and a thermal fuse device that are tightly adjacent and connected in series, wherein the action unit includes a movable contact device and a fixed contact device; the movable contact device includes a bimetallic strip and a movable contact; the action unit is turned off or turned on under an action of the bimetallic strip; and an action temperature of the thermal fuse device is higher than an action temperature of the bimetallic strip.

When the action unit is closed, a path of the movable contact device, the fixed contact device and the thermal fuse device is formed, or a path of the fixed contact device, the movable contact device and the thermal fuse device is formed. The action unit is tightly adjacent to the thermal fuse device, shortening the heat conduction path, so that the thermal fuse device can accurately sense the temperature of the circuitry. When the action unit fails and the temperature is higher than an action temperature of the bimetallic strip, the thermal fuse device can accurately perform protection in time.

Further, the fixed contact device includes a fixed contact configured to be correspondingly in contact with the movable contact, and the movable contact and the fixed contact are disconnected or connected under the action of the bimetallic strip. When a circuit reaches a certain temperature, the bimetallic strip acts, and the movable contact and the fixed contact are disconnected or connected under the action of the bimetallic strip, so that the circuit is turned off or turned on.

Further, the movable contact is provided on the bimetallic strip. When the bimetallic strip is heated to generate a deformation action, the bimetallic strip directly drives the movable contact to move, thereby disconnecting or connecting the movable contact and the fixed contact.

Further, one end of the bimetallic strip is fixed, and the movable contact is provided at the other end of the bimetallic strip.

Further, the movable contact device further includes a movable reed, the movable contact is provided on the movable reed, and the bimetallic strip moves to drive the movable reed to move. When the bimetallic strip is heated to generate a deformation action, the movable reed moves to drive the movable contact on the movable reed to move under the deformation action of the bimetallic strip, thereby disconnecting or connecting the movable contact and the fixed contact.

Further, one end of the movable reed and one end of the bimetallic strip are fixed together, and the movable contact is provided on the other end of the movable reed. When the bimetallic strip is heated to generate a deformation action, since one end of the bimetallic strip is fixed, the other end of the bimetallic strip will be deformed, which will force the other end of the movable reed to follow and thus drive the movable contact on the other end of the movable reed to move, thereby disconnecting or connecting the movable contact and the fixed contact.

Further, the thermal fuse device includes a fluxing agent and a fusible alloy wrapped with the fluxing agent.

Further, the fusible alloy is in a form of wires or strips.

Further, a plurality of fusible alloys are connected in parallel.

Further, the action unit is connected to a first pin, the thermal fuse device is connected to a second pin, the action unit and the thermal fuse device are packaged in the same outer casing, and the first pin and the second pin are extended out of the outer casing. Thus, a single component is formed, which is easy to install directly in a circuit.

The advantages of the present invention include at least.

When a large current flows through a snap-action temperature controller, the contacts are adhered together, and when a circuit cannot be disconnected, the temperature rises abnormally during the adhesion of the contacts. Since the contacts of the action unit and a fusible alloy of a fuse unit are located at the same conduction path, a heat transfer path is shortened, thermal diffusion is reduced, and heat may quickly be transmitted to the fusible alloy in the same casing. The fusible alloy is heated and shrinks toward conductors at both sides under a tension of a fluxing agent, so that the circuit is safely disconnected, and the circuitry safety is effectively protected.

The above description is only an overview of the technical solutions of the present invention. In order to understand the technical means of the present invention more clearly, it can be implemented in accordance with the contents of the description, and in order to make the above and other objectives, features and advantages of the present invention more obvious and understandable, the specific embodiments of the present invention are specifically exemplified below.

### BRIEF DESCRIPTION OF THE DRAWINGS

The present invention will be further described below in conjunction with the following accompanying drawings.

FIG. 1 is a circuit diagram of the present invention;

FIG. 2 is a schematic diagram showing a normally closed structure of Embodiment 2 of the present invention;

FIG. 3 is a schematic diagram showing an action of the normally closed structure of Embodiment 2 of the present invention;

FIG. 4 is a schematic diagram showing fixed reed end thermal protection of the normally closed structure of Embodiment 2 of the present invention;

FIG. 5 is a schematic diagram showing a normally closed structure of Embodiment 3 of the present invention;

FIG. 6 is a schematic diagram showing an action of the normally closed structure of Embodiment 3 of the present invention;

FIG. 7 is a schematic diagram showing fixed reed end thermal protection of the normally closed structure of Embodiment 3 of the present invention;

FIG. 8 is a schematic diagram showing a normally opened structure of Embodiment 4 of the present invention;

FIG. 9 is a schematic diagram showing an action of the normally opened structure of Embodiment 4 of the present invention; and

FIG. 10 is a schematic diagram showing movable reed end thermal protection of the normally opened structure of Embodiment 4 of the present invention.

In the figures:
101 First pin
102 Action unit
103 Connecting line
104 Thermal fuse device
105 Second pin
201 Outer casing
202 Base
203 First connecting line
204 Bimetallic strip
205 Movable contact
206 Fixed contact
207 Fixed reed
208 Fusible alloy
208a Left-side shrinking alloy
208b Right-side shrinking alloy
209 Fluxing agent
210 Connecting piece
211 Sealing glue
212 Second connecting line
301 Outer casing
302 Base
303 First connecting line
304 Fixed piece
305 Bimetallic strip
306 Movable reed
307 Rivet
308 Movable contact
309 First connecting pin
310 Fusible alloy
310a Left-side shrinking alloy
310b Right-side shrinking alloy
311 Fluxing agent
312 Second connecting pin
313 Sealing glue
314 Second connecting line
401 First connecting pin
402 Metal outer casing
402a Fixed contact
403 Movable contact
404 Bimetallic strip
405 Support
406 First copper foil pin
407 Fusible alloy
407b Right-side shrinking alloy
407a Left-side shrinking alloy
408 Fluxing agent
409 Second connecting pin
410 Second copper foil pin
411 First insulating layer
412 Second insulating layer

### DETAILED DESCRIPTION OF THE EMBODIMENTS

In order to make objectives, technical solutions and advantages of the embodiments of the present invention more clear, the technical solutions in the embodiments of the present invention are clearly and completely described below in conjunction with the accompanying drawings in the embodiments of the present invention. Obviously, the described embodiments are a part of the embodiments of the present invention, not all of the embodiments. All other embodiments obtained by those of ordinary skill in the art based on the embodiments in the present invention without creative efforts shall fall within the scope of protection of the present invention.

The present invention is specifically described below with reference to the accompanying drawings.

### Embodiment 1

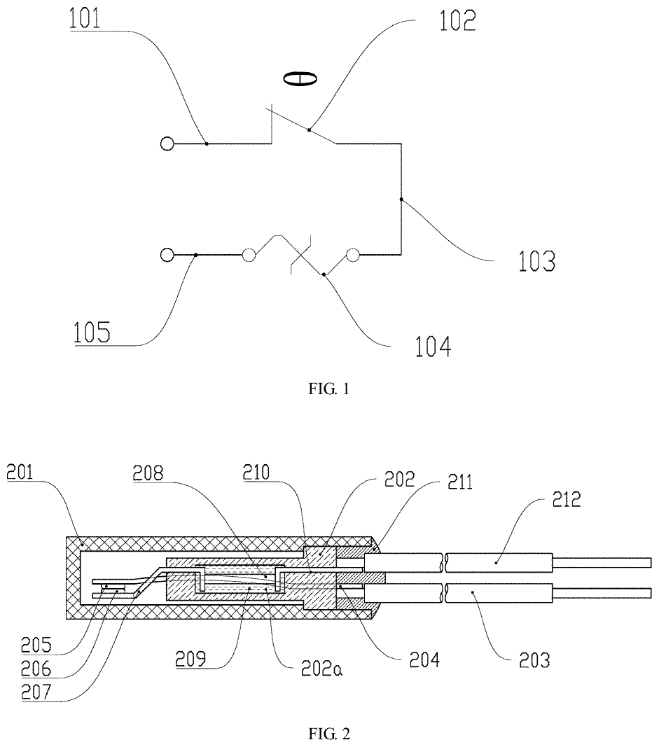

As shown in FIG. 1, a temperature controller with thermal protection includes the first pin 101, the action unit 102, the connecting line 103, the thermal fuse device 104 and the second pin 105. Specifically, the action unit 102 adopts a bimetallic strip as a thermosensitive element to drive the closing/opening of contacts. The thermal fuse device 104 adopts a fusible alloy wrapped with a fluxing agent as a fuse body, and both ends of the fusible alloy are connected to the connecting line 103 and the second pin 105 respectively, to form an electrical connection between the action unit 102 and the thermal fuse device 104. Specifically, the connecting line 103 is a common pin of the contacts of the action unit 102 and the fusible alloy of the thermal fuse device 104.

### Embodiment 2

As shown in FIGS. 2, 3, and 4, the insulating base 202 is provided in the outer casing 201. The movable contact device includes the bimetallic strip 204 and the movable contact 205, wherein one end of the bimetallic strip 204 is fixed in the base 202, and the other end of the bimetallic strip 204 is provided with the movable contact 205. The fixed contact device includes the fixed contact 206 and the fixed reed 207. The movable contact 205 and the fixed contact 206 are provided directly opposite to each other. The fixed contact 206 is located at one end of the fixed contact device, and is connected to one end of the fusible alloy 208 coated with the fluxing agent 209 through the fixed reed 207. The other end of the fusible alloy 208 is connected to the connecting piece 210. Specifically, the cavity 202a is provided on the base 202, and the fusible alloy 208 wrapped with the fluxing agent 209 is provided in the cavity 202a. Both the fixed reed 207 and the connecting piece 210 are partially exposed on the base 202. According to the application requirements, the first connecting line 203 is provided at an end of the bimetallic strip 204 exposed at the base 202 to be connected to the bimetallic strip 204, and the second connecting line 212 is provided at an end of the connecting piece 210 exposed to the base 202 to be connected to the connecting piece 210, and therefore the electrical connection between the first connecting line 203, the bimetallic strip 204, the movable contact 205, the fixed contact 206, the fusible alloy 208, the connecting piece 210 and the second connecting line 212 is formed. The sealing glue 211 is adopted for sealing and packaging.

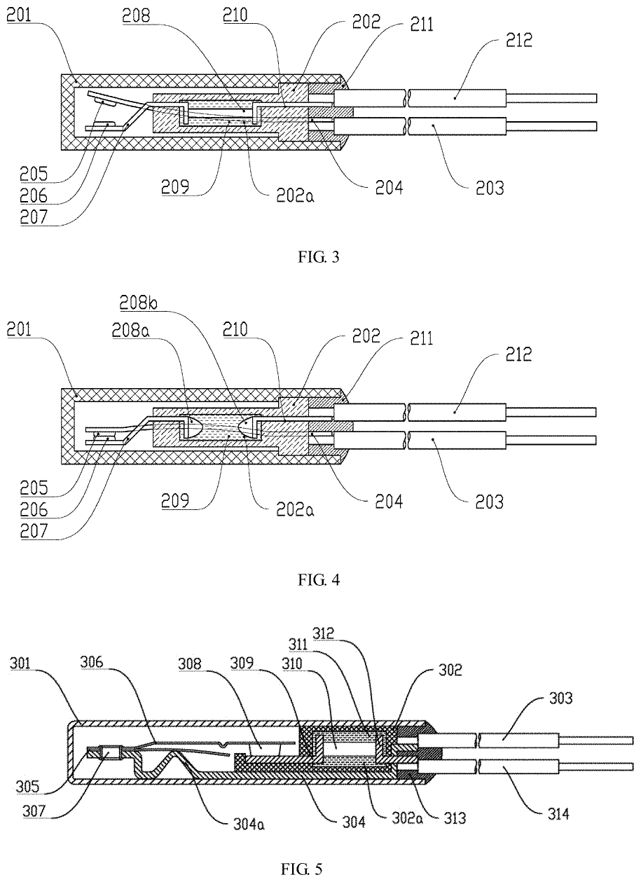

When electrical equipment is operating normally, the device is in an operating state as shown in FIG. 2, and the movable contact 205 and the fixed contact 206 are in normal contact. When an abnormal temperature rise or overcurrent occurs outside, as shown in FIG. 3, when the heat reaches a deformation temperature of the bimetallic strip 204, the bimetallic strip 204 acts to drive the movable contact 205 to move away from the fixed contact 206, thereby disconnecting the entire circuit. When a reset temperature is reached, the bimetallic strip 204 resets to reconnect the circuit.

As shown in FIG. 4, when the movable contact 205 and the fixed contact 206 are adhered, the heat generated during the adhesion is transferred to the fusible alloy 208 through the fixed reed 207. When the temperature reaches an action temperature of the fusible alloy 208, under the tension of the fluxing agent 209, the fusible alloy 208 moves toward connecting points on both sides, forming the left-side shrinking alloy 208a attached to the fixed reed 207 and the right-side shrinking alloy 208b attached to the connecting piece 210, thereby disconnecting the circuit and preventing the occurrence of secondary disasters.

### Embodiment 3

As shown in FIGS. 5, 6, and 7, the insulating base 302 is provided in the outer casing 301. The cavity 302a is provided on the insulating base 302, and the fusible alloy 310 coated with the fluxing agent 311 is provided in the cavity 302a. The movable contact device includes the movable reed 306, the bimetallic strip 305 and the movable contact 308. The fixing piece 304 with a conductive function is fixed on the base 302. One end of the fixing piece 304 is exposed on the base 302 and is connected to the first connecting line 303. The other end of the fixing piece 304 is extended out of the base 302 to be laminated with one end of the bimetallic strip 305 and one end of the movable reed 306, and they are fixed together by the rivet 307. The movable contact 308 is provided on the other end of the movable reed 306, and the first connecting pin 309 is provided directly opposite to the movable contact 308. One end of the first connecting pin 309 is provided with a fixed contact in contact with the movable contact, and the other end of the first connecting pin 309 is connected to one end of the fusible alloy 310 coated with the fluxing agent 311. The other end of the fusible alloy 310 is connected to one end of the second connecting pin 312, and the other end of the second connecting pin 312 is exposed at an end of the base 302 to be connected to a second connecting line 314, and therefore, the electrical connection between the first connecting line 303, the fixing piece 304, the rivet 307, the movable reed 306, the movable contact 308, the first connecting pin 309, the fusible alloy 310, the second connecting pin 312 and the second connecting line 314 is formed. The sealing glue 313 is adopted for sealing and packaging.

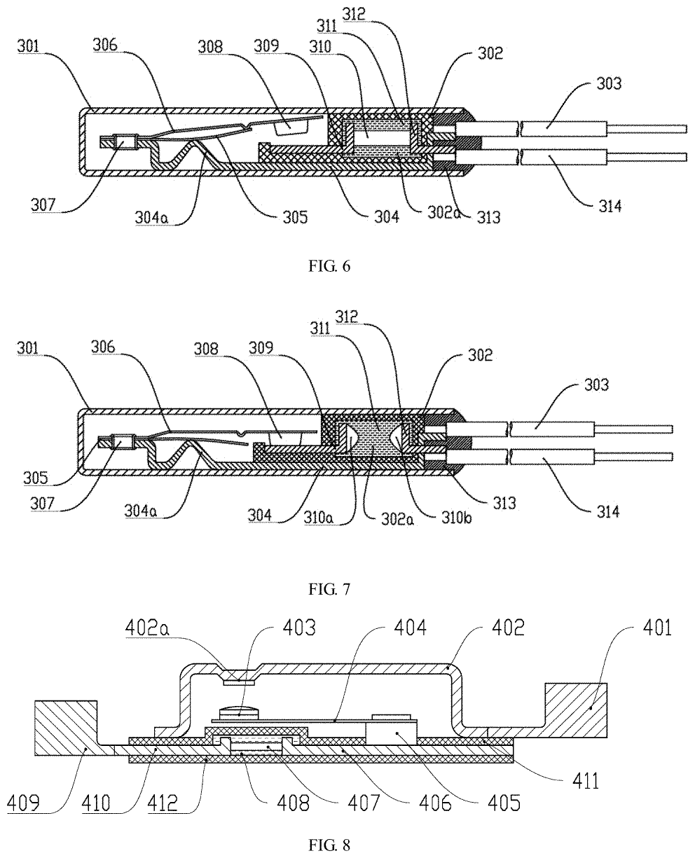

When electrical equipment is operating normally, the device is in an operating state as shown in FIG. 5, and the movable contact 308 and the first connecting pin 309 are in normal contact. When the temperature rises abnormally outside, as shown in FIG. 6, when the heat reaches a deformation temperature of the bimetallic strip 305, the bimetallic strip 305 acts to push the movable reed 306 with the convex hull 304a as a supporting point, and to drive the movable contact 308 to move away from the first connecting pin 309, thereby disconnecting the entire circuit. When a reset temperature is reached, the bimetallic strip 305 resets, and the movable reed 306 is elastically reset to drive the movable contact 308 to reconnect to the circuit.

As shown in FIG. 7, when the movable contact 308 and the first connecting pin 309 are adhered, the heat generated during the adhesion is transferred to the fusible alloy 310 through the first connecting pin 309. When the temperature reaches an action temperature of the fusible alloy 310, under the tension of the fluxing agent 310, the fusible alloy 311 moves toward connecting points on both sides, forming the left-side shrinking alloy 310a attached to the first connecting pin 309 and the right-side shrinking alloy 310b attached to the second connecting pin 312, thereby disconnecting the circuit and preventing the occurrence of secondary disasters.

### Embodiment 4

As shown in FIGS. 8, 9, and 10, the fixed contact 402a is provided on the inner cavity wall of the metal outer casing 402, and the first connecting pin 401 is externally connected to the metal outer casing 402. The movable contact 403 is provided at a distance directly opposite to the fixed contact 402a. The movable contact 403 is installed on one end of the bimetallic strip 404, and the other end of the bimetallic strip 404 is fixed to the support 405. The support 405 is connected to the first copper foil pin 406. One end of the first copper foil pin 406 is connected to one end of the fusible alloy 407 coated with the fluxing agent 408, the other end of the fusible alloy 407 is connected to one end of the second copper foil pin 410, and the other end of the second copper foil pin 410 is connected to the second connecting pin 409. Specifically, the first insulating layer 411 is provided between the outer casing 402 and the first copper foil pin 406 and the second copper foil pin 410, and the second insulating layer 412 is provided between the first copper foil pin 406, the second copper foil pin 410 and the other surface.

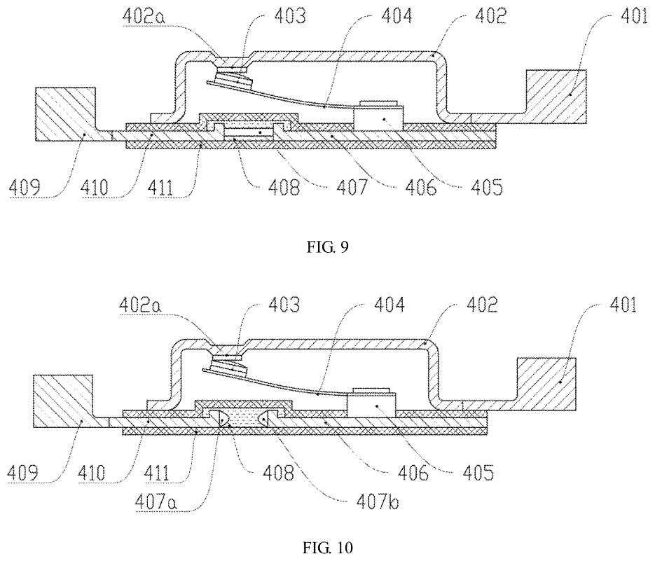

When electrical equipment is operating normally, the device is in an operating state as shown in FIG. 8, and the fixed contact 402a and the movable contact 403 are not conductive. When the temperature rises abnormally outside, as shown in FIG. 9, when the heat reaches a deformation temperature of the bimetallic strip 404, the bimetallic strip 404 acts to drive the movable contact 403 to move towards the fixed contact 402a, thereby connecting the fixed contact 402a and the movable contact 403, forming the electrical connection between the first connecting pin 401, the metal outer casing 402, the fixed contact 402a, the movable contact 403, the bimetallic strip 404, the support 405, the first copper foil pin 406, the fusible alloy 407, the second copper foil pin 410 and the second connecting pin 409, and closing the entire circuit. When a reset temperature is reached, the bimetallic strip 404 resets to drive the movable contact 403 to detach from the fixed contact 402a, thereby disconnecting the circuit again.

As shown in FIG. 10, when the fixed contact 402a and the movable contact 403 are connected, a large current passes through the circuit, causing the fixed contact 402a and the movable contact 403 to be adhered. When the circuit cannot be disconnected, the heat generated during the adhesion of the contacts is transferred to the fusible alloy 407 through the bimetallic strip 404, the support 405 and the first copper foil pin 406. When the temperature reaches an action temperature of the fusible alloy 407, under the tension of the fluxing agent 408, the fusible alloy 407 moves toward connecting points on both sides, forming the right-side shrinking alloy 407b attached to the first copper foil pin 406 and the left-side shrinking alloy 407a attached to the second copper foil pin 410, thereby disconnecting the circuit and preventing the occurrence of secondary disasters.

It should be understood that the embodiments of the present invention are merely examples for clearly illustrating the present invention, and are not intended to limit the present invention. Although the present invention has been described in detail with reference to the embodiments, for those skilled in the art, it is still possible to make other changes or modifications in different forms or equivalently replace some of the technical features on the basis of the above description. However, any modification, equivalent replacement, improvement, etc. made within the spirit and principles of the present invention shall fall within the scope of protection of the present invention.

What is claimed is:

1. A temperature controller with thermal protection, comprising an action unit and a thermal fuse device, wherein the action unit and the thermal fuse device are tightly adjacent and connected in series; the action unit comprises a movable contact device and a fixed contact device; the movable contact device comprises a bimetallic strip and a movable contact; and the action unit is turned off or turned on under an action of the bimetallic strip.

2. The temperature controller according to claim 1, wherein, the fixed contact device comprises a fixed contact, the fixed contact corresponds to the movable contact and is in contact with the movable contact, and the movable contact and the fixed contact are disconnected or connected under the action of the bimetallic strip.

3. The temperature controller according to claim 1, wherein, the movable contact is provided on the bimetallic strip.

4. The temperature controller according to claim 3, wherein, a first end of the bimetallic strip is fixed, and the movable contact is provided at a second end of the bimetallic strip.

5. The temperature controller according to claim 1, wherein, the movable contact device further comprises a movable reed, the movable contact is provided on the movable reed, and the bimetallic strip moves to drive the movable reed to move.

6. The temperature controller according to claim 5, wherein, a first end of the movable reed and a first end of the bimetallic strip are fixed together, and the movable contact is provided on a second end of the movable reed.

7. The temperature controller according to claim 1, wherein, the thermal fuse device comprises a fluxing agent and a plurality of fusible alloys coated with the fluxing agent.

8. The temperature controller according to claim 7, wherein, the plurality of fusible alloys are in a form of wires or a form of strips.

9. The temperature controller according to claim 7, wherein, the plurality of fusible alloys are connected in parallel.

10. The temperature controller according to claim 1, wherein, the action unit is connected to a first pin, the thermal fuse device is connected to a second pin, the action unit and the thermal fuse device are packaged in an outer casing, and the first pin and the second pin are extended out of the outer casing.

11. The temperature controller according to claim 1, wherein, an action temperature of the thermal fuse device is higher than an action temperature of the bimetallic strip.

12. The temperature controller according to claim 2, wherein, the movable contact and the fixed contact are provided directly opposite to each other.

13. The temperature controller according to claim 5, wherein, the bimetallic strip uses a convex hull as a supporting point to drive the movable reed to move.

14. The temperature controller according to claim 6, wherein, the first end of the movable reed and the first end of the bimetallic strip are fixed together by a rivet.
